(19) United States
(12) Patent Application Publication
(10) Pub. No.: US 2010/0027253 A1
(43) Pub. Date: Feb. 4, 2010

(54) LIGHTING DEVICE FOR ROASTING ZONE OF OUTDOOR BARBEQUE TABLE

(76) Inventor: WILLIAM HOME, Taipei (TW)

Correspondence Address: LEONG C LEI, PMB # 1008, 1867 YGNACIO VALLEY ROAD, WALNUT CREEK, CA, 94598, US

(21) Appl. No.: 12/184,257

(22) Filed: Aug. 1, 2008

(51) Int. Cl. F21L 4/00

(52) U.S. Cl. 362/190

(57) ABSTRACT

A lighting device is provided for a roasting zone of an outdoor barbeque table, wherein a flap-up cover is provided for a roasting tray and has a flapping edge from which a handle projects outwards. The handle receives an electrically-powered lighting assembly therein at a suitable location for illuminating inside of the cover. With the handle is located further from the roasting zone than a wall of the roasting tray, and further with the roasting tray cover featuring heat isolation and dissipation, heat generated by the roasting zone does not directly impinge and thus damage the electrically-powered lighting assembly. Light is projected into the cover, rather than toward a user's eyes to dazzle the user. In this way, the lighting of the outdoor barbeque table can be improved and is more reliable and durable. Assembling and replacement/maintenance can be made simple and the structure simplified and costs reduced.

### BACKGROUND OF THE INVENTION

(a) Technical Field of the Invention

The present invention relates to improvement on lighting for a roasting zone of an outdoor barbeque table, and in particular to a novel lighting assembly of an outdoor barbeque table wherein an electrically-powered lighting assembly is arranged inside a handle that extends horizontally from a flap-up cover for a roasting tray for illuminating inside of the cover so as to reduce the risk that the electrically-powered lighting assembly is damaged by the high temperature and the illuminating light is not directly projected onto a user's eyes, thereby making the lighting of the outdoor barbeque table reliable and durable, simplifying assembling and maintenance/replacement thereof, and reducing the costs with a simplified construction.

(b) Description of the Prior Art

One of the most commonly used ways of outdoor cooking is barbequing or roasting. Around the world, residents of many countries and/or communities often set up outdoor barbeque table or cart in a back yard for easy preparation a barbeque party at any time. Some house backyards have beautiful gardens and thus owners of these gardens often wish to have a beautiful set of barbeque device their backyards.

Thus, various outdoor barbeque devices are available in the market, and such devices are often durable and weather resistant. Some are fixed type, having stands or legs secured to the ground, while the other are movable and in the form of a cart having casters or wheels to facilitate movement of the barbeque device to a desired site in the backyard. FIG. 1 of the attached drawings shows a conventional outdoor barbeque table, generally designated at 1. To allow a user to clearly watch a roasting zone 2 of the barbeque table 1, even in a dark environment, where surrounding light is poor or dim, or at the nighttime, without being affected by the constantly swaying flaming, and also to make it possible to clearly watch the back side of the food being barbequed, where it is not possible to be observed through the swaying barbeque flaming, the outdoor barbeque device is provided, at a rear side wall 3 thereof, with a heat-resistant light-transmitting window 4 in which an electrically-powered lighting assembly (which is often constituted by for example a lighting bulb, a switch, and a battery connected to each other, similar to a flashlight, and not shown in the drawings) is embedded in the wall. In this way, once the lighting from the window 4 is turned on, the roasting zone 2 of the barbeque table can be clearly illuminated even in a dim-light environment or at the nighttime, without being affected by the variable and swaying barbeque flaming, and also, illumination of the back side of food that is being barbequed can also be made.

However, since the electrically-powered lighting assembly arranged in the heat-resistant light-transmitting window 4 is separated from the roasting zone 2 of the barbeque table by the heat-resistant light-transmitting window 4 and the rear wall 3 that are thin and is still be close to the roasting zone 2, a great amount of heat generated by the roasting operation is transferred into the electrically-powered lighting assembly, causing damage of the electrically-powered lighting assembly. Thus, the conventional barbeque lighting is not reliable and durable. Further, since the light emitting from the heat-resistant light-transmitting window 4 is projected in a direction toward a user that does barbequing with the barbeque table, dazzling of the user's eyes may occur when the user is standing or sitting in front of the roasting tray of the barbeque table where the user's eyes are easily positioned opposing the light from the heat-resistant light-transmitting window 4. This makes the user's eyes feel uncomfortable in doing barbequing.

Other disadvantages of the conventional barbeque table include:

(1) Since the electrically-powered lighting assembly is set in the rear wall of the barbeque table, wire arrangement becomes difficult and at least some wires have to be set from the rear side of the barbeque table to the front side where the wires are connected to a lighting switch in a front panel of the barbeque table.

(2) Some of the barbeque table users are residents of suburban areas or even rural areas, or they wish to do barbeque while they are traveling, when or where availability of after-sale service is in general very difficult or impossible. Under such situations, trouble shooting and repairing done by the users themselves is a more feasible way for failure handling. However, the conventional barbeque device, which sets the electrically-powered lighting assembly in the rear wall, makes it very difficult for the user to handle any operation failure problem and to do maintenance and replacement of parts thereof.

(3) The conventional barbeque table has a complicated structure for the electrically-powered lighting assembly has to be arranged close to the roasting tray and this also increases the costs.

The present invention is aimed to overcome the above problems.

### SUMMARY OF THE INVENTION

The improvement made on the lighting of the outdoor barbeque table by the present invention is to not set the electrically-powered lighting assembly in the rear wall of a roasting tray and researches indicate that the electrically-powered lighting assembly is less subjected to heat damage by being arranged at a suitable location in a handle that extends horizontally from a flap-up cover for the roasting tray of the barbeque table. Further, with such an arrangement, light is projected in a downward direction toward the roasting zone with a widened angular range of illumination, and is not projected directly onto a user's eyes to dazzle the user. In this way, the lighting of the outdoor barbeque table can be made more reliable and durable. This is a primary objective of the present invention.

Further, the improvement made on the lighting of the outdoor barbeque table by the present invention is to set the electrically-powered lighting assembly in a cover handle that is located close to a user, whereby wiring arrangement of the electrically-powered lighting assembly can be simplified and not extending through a high temperature area of the barbeque table. This is another objective of the present invention.

Further, the improvement made on the lighting of the outdoor barbeque table by the present invention allows easy repairing of a malfunctioning lighting assembly by simply replacing the handle in which the electrically-powered lighting assembly is arranged and the associated support/rack whereby after-sale service is made easy and a user is allowed to do the repairing by himself or herself if necessary by simply removing and replacing the malfunctioning lighting assembly with a spare one. This is a further objective of the present invention.

Further, the improvement made on the lighting of the outdoor barbeque table by the present invention make it possible not to set the electrically-powered lighting assembly close the roasting try, but still providing effective illumination thereto, whereby no structure that functions to resist damage caused by heat is needed to enhance heat dissipation of components of the electrically-powered lighting assembly or no heat dissipation elements is needed for the electrically-powered lighting assembly and consequently, the overall structure is simplified and the costs are reduced. This is yet a further objective of the present invention.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view illustrating a conventional outdoor barbeque table of which a cover is opened to uncover a heat-resistant light-transmitting window;

FIG. 2 is a perspective view of an outdoor barbeque table in which a lighting device in accordance with the present invention is provided for lighting a roasting zone of the outdoor barbeque table;

FIG. 3 is a side elevational view of the outdoor barbeque table with a handle broken to illustrate an electrically-powered lighting assembly in accordance with the present invention;

FIG. 4 shows the use of the outdoor barbeque table of FIG. 2;

FIG. 5 is a cross-sectional view of the lighting device constructed in accordance with another embodiment of the present invention for lighting a roasting zone of an outdoor barbeque table; and

FIG. 6 shows the use of the outdoor barbeque table of FIG. 5.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

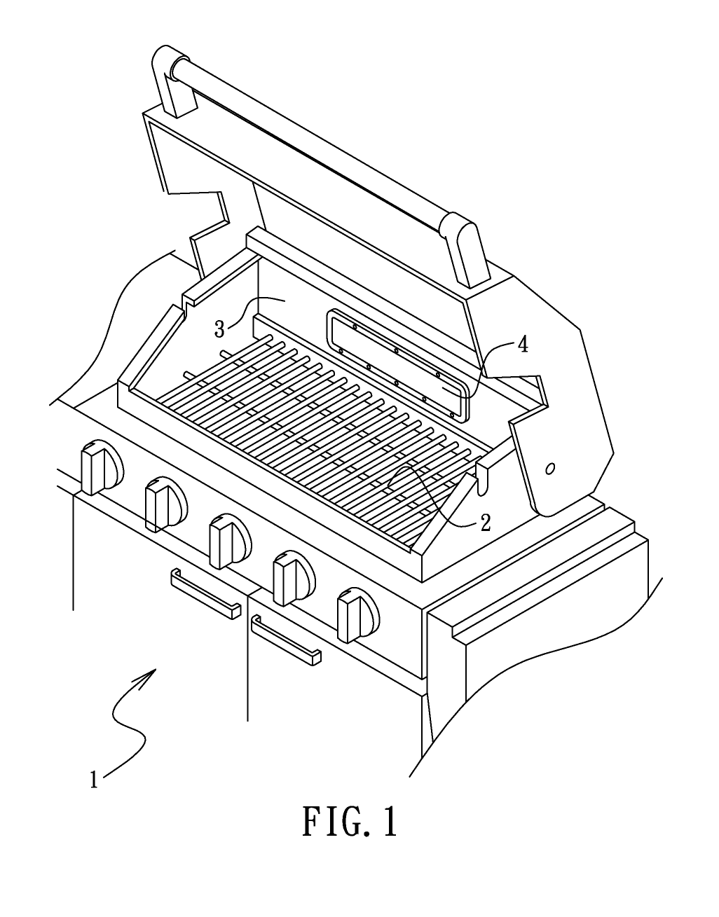

FIG. 1 is a perspective view illustrating a conventional outdoor barbeque table of which a cover is opened to uncover a heat-resistant light-transmitting window. The structure of lighting for a roasting zone of the conventional barbeque table, as well as the drawbacks thereof, has been discussed in the previous section and further discussion is omitted here for not repeating.

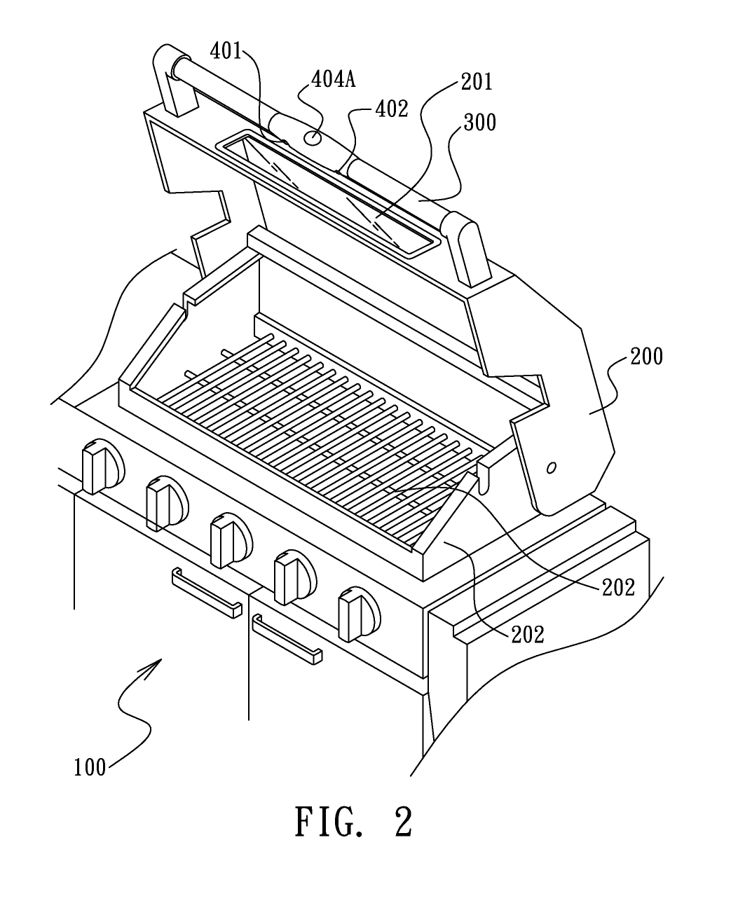

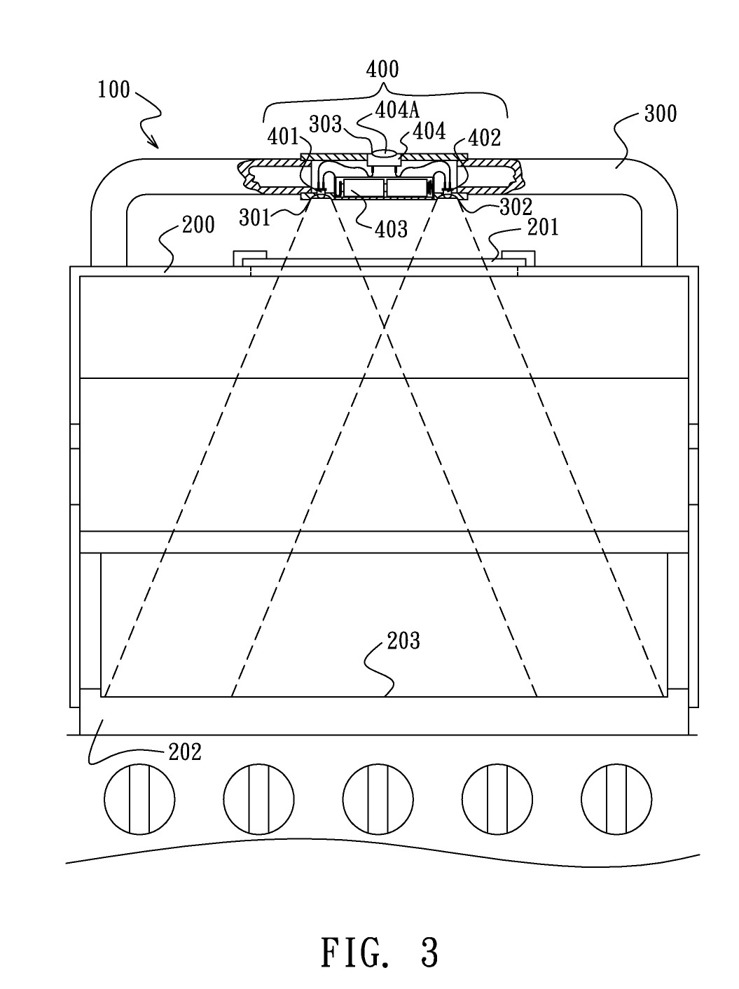

FIG. 2 is a perspective view of an outdoor barbeque table in which a lighting device in accordance with the present invention is provided for lighting a roasting zone of the outdoor barbeque table and FIG. 3 is a side elevational view of the outdoor barbeque table with a handle broken to illustrate an electrically-powered lighting assembly in accordance with the present invention. As can be known from these drawings, the lighting device for the roasting zone of the outdoor barbeque table in accordance with the present invention features that the barbeque table, which is generally designated at 100, has a roasting tray that is selectively and openably covered by a flap-up cover 200. The cover 200 has a flapping edge from which a handle 300 projects outwards. Inside the handle 300, the electrically-powered lighting assembly, generally designated at 400, is arranged at a suitable location for illuminating inside of the cover 200. The assembly 400 is formed by properly connecting at least one light-emitting diode 401, 402, at least one battery 403, and a lighting switch 404. As shown, the assembly 400 can be arranged, in a concentrated manner, at a central portion of the handle 300. On one side of the central portion of the handle 300 that faces toward the cover 200, openings 301,302 are formed for exposing light-emitting terminals of the light-emitting diodes 401, 402. On the opposite side of the central portion of the handle 300 that faces away from the cover 200, an opening 303 is formed to expose an operation button 404A of the lighting switch 404. The cover 200 forms, at a location corresponding to the light-emitting terminals of the light-emitting diodes 401, 402, a window opening in which a thermal isolation glass panel 201 is embedded.

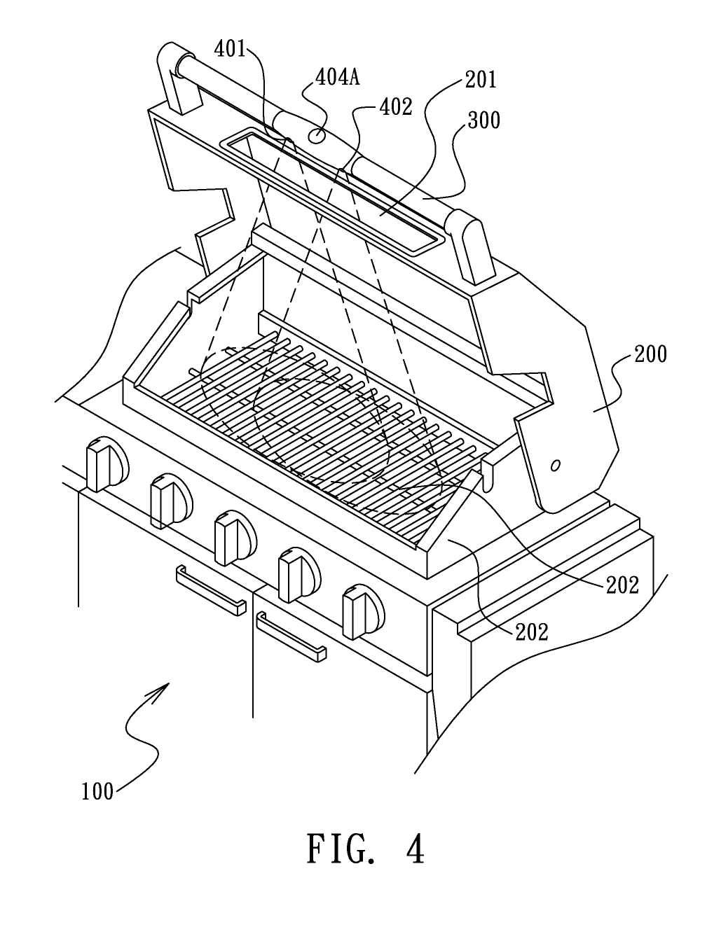

FIG. 4 shows the use of the present invention. In using the barbeque table 100, the operation button 404A that is exposed or projects outside the handle 300 that extends from the cover 200 to light up the light-emitting diodes 401, 402, which emit light through the thermal isolation glass panel 201 into a roasting zone 203 delimited in a roasting tray 202. Since the cover 200 has a pivot that is slightly higher than the roasting zone 203 by a small distance, no matter to how wide the cover 200 is opened, once the operation button 404A is actuated, the light-emitting diodes 401, 402 emit light beams to the roasting zone 203. And, when the cover 200 is set in a closed condition that completely covers the roasting tray 202, a user may still be able to inspect the roasting condition inside the roasting tray 202 by watching through the glass panel 201. Since the roasting tray cover 200 features moderate thermal isolation and dissipation, the heat generated in the roasting zone does not directly damage the electrically-powered lighting assembly 400 (reference 400 being shown in the previously discussed drawings), and further, the light-emitting diodes 401, 402 project light in a direction into the barbeque device, rather than toward a user's eyes, whereby the lighting of the roasting zone of the outdoor barbeque table in accordance with is made more reliable and durable.

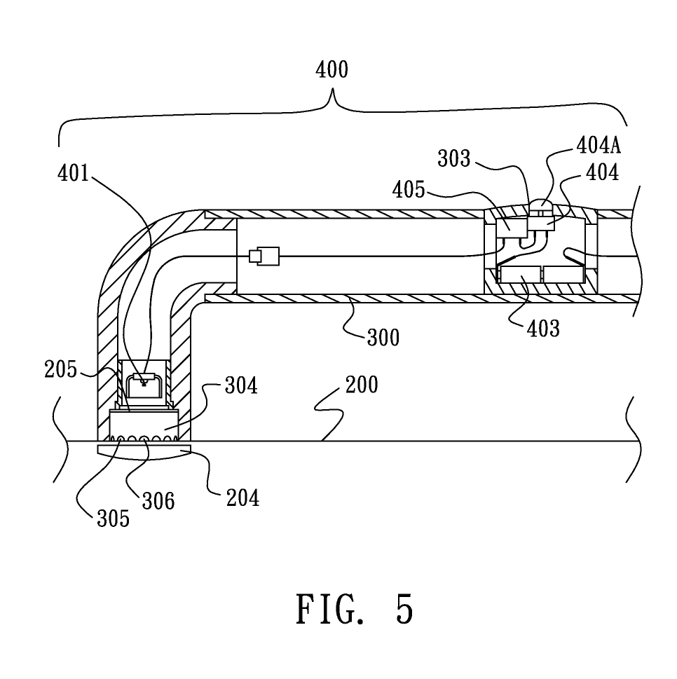

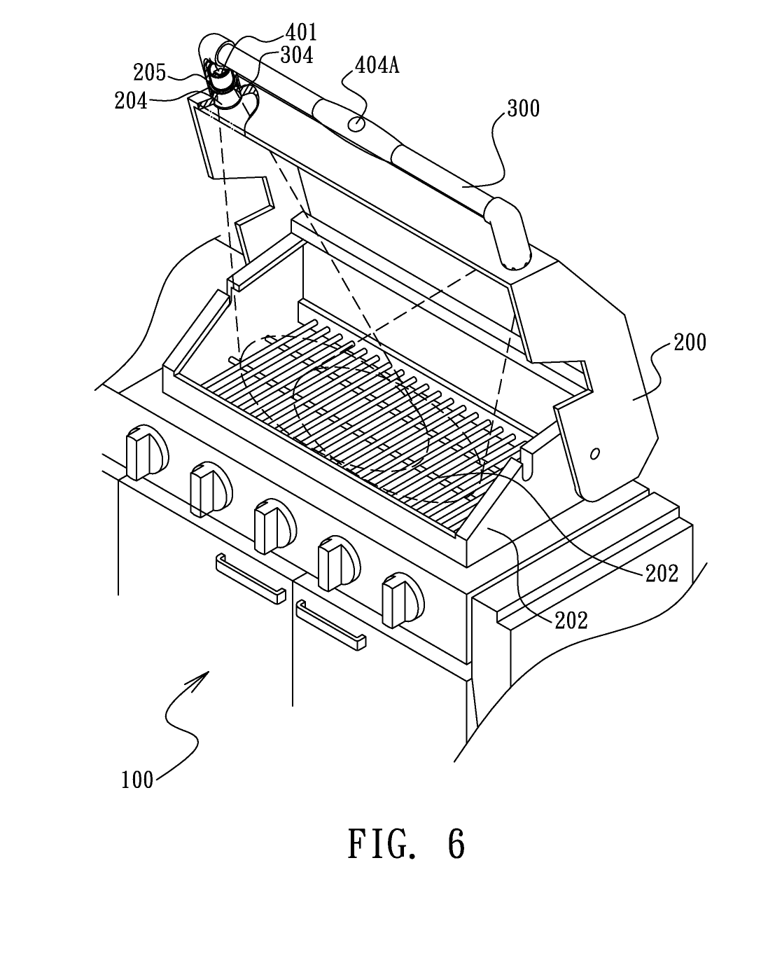

The present invention can be embodied as illustrated in FIG. 5, wherein the light-emitting diode 401 of the electrically-powered lighting assembly 400 is inlayed inside an open end 304 he handle 300 that is made hollow and in connection with the roasting tray cover 200. The handle 300 is provided with a plurality of vent holes 305, 306 in a portion of a wall thereof in the proximity of the end opening 304. Further, a first thermal isolation glass board 204 that forms a convex lens is embedded in the end 30 of the handle 300 that is substantially flush with and is jointed to a rim of the roasting tray cover 200 and a second thermal isolation glass board 205 is received in the handle 300 and overlaps a light-emitting terminal of the light-emitting diode 401. Besides the light-emitting diodes 401, 402, the battery 403, and the lighting switch 404, the electrically-powered lighting assembly 400 may also include an inclination-sensitive shutoff 405. With reference to FIG. 6 that shows the use of the barbeque table of the present invention, the cover 200 is opened and set in position and the operation button 404A of the cover 200 that projects out of the handle 300 is actuated, whereby the light-emitting diode 401 emits light that travels through the second thermal isolation glass board 205 and the first thermal isolation glass board 204 to radiate the roasting zone 203 of the roasting tray 202. When the cover 200 is open and set in an inclined condition, the inclination-sensitive shutoff 405 does not operate to cut off power supply and electrical power supplied to the electrically-powered lighting assembly 400 is maintained. When the cover 200 is moved downward to have the cover 200 closed for carrying out muffled roasting, even thought the lighting switch 404 is not turned off, the inclination-sensitive shutoff 405 is set in operation to automatically cut off the power supply and shut down the lighting for preservation of the power storage of the battery 403. Again, the heat generated by the roasting operation carried out in the roasting zone does not directly impinge and thus damage the electrically-powered lighting assembly 400 and the light-emitting diodes 401, 402 project light in a direction into the barbeque device, rather than toward a user's eyes, whereby the lighting of the roasting zone of the outdoor barbeque table in accordance with is made more reliable and durable and the maintenance/replacement and assembling/disassembling thereof are made easy and convenient.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A lighting device for a roasting zone of an outdoor barbeque table characterized in that a flap-up cover is adapted to mount to the outdoor barbeque table and has a flapping edge from which a handle projects outwards, the handle receiving an electrically-powered lighting assembly therein at a suitable location for illuminating inside of the cover, the electrically-powered lighting assembly comprising at least one light-emitting diode, at least one battery, and a lighting switch, which are connected together, the electrically-powered lighting assembly being arranged in a concentrated manner at a central portion of the handle, the handle forming an opening on one side of the central portion thereof that faces toward the cover for exposing a light-emitting terminal of the light-emitting diode and also forming an opening on an opposite side of the central portion thereof the handle that faces away from the cover for exposing an operation button of the lighting switch, the cover forming, at a location corresponding to the light-emitting terminal of the light-emitting diode, a window opening in which a thermal isolation glass panel is embedded.

2. A lighting device for a roasting zone of an outdoor barbeque table characterized in that a flap-up cover is adapted to mount to the outdoor barbeque table and has a flapping edge from which a handle projects outwards, the handle receiving an electrically-powered lighting assembly therein at a suitable location for illuminating inside of the cover, the electrically-powered lighting assembly comprising at least one light-emitting diode, at least one battery, a lighting switch, and an inclination-sensitive shutoff, which are connected together, a first thermal isolation glass board being embedded in an end opening of the handle that is jointed to the cover, a second thermal isolation glass board being received in the handle and overlapping a light-emitting terminal of the light-emitting diode.

3. The lighting device as claimed in claim 2, wherein the handle forms a plurality of vent holes in a portion of a wall in the proximity of an end opening.

4. The lighting device as claimed in claim 2, wherein the first thermal isolation glass board forms a convex lens.
